(19) United States
(12) Patent Application Publication
(10) Pub. No.: US 2009/0314141 A1
(43) Pub. Date: Dec. 24, 2009

(54) Bicycle Lock/Wrench

(76) Inventors: Lee Weinstein, Arlington, MA (US); William Sebell, Sudbury, MA (US)

Correspondence Address: LEE WEINSTEIN, 32A FAIRMONT STREET, ARLINGTON, MA, 02474, US

(21) Appl. No.: 12/456,831

(22) Filed: Jun. 22, 2009

Related U.S. Application Data
(60) Provisional application No. 61/132,966, filed on Jun. 23, 2008.

(51) Int. Cl. B25B 23/00; B23P 11/00; E05B 71/00

(52) U.S. Cl. 81/180.1; 29/525.11; 70/233; 70/431

(57) ABSTRACT

Several embodiments are described which allow either the U-bar or the straight bar of a bicycle U-lock to act as the lever arm of a wrench which may be used to remove the wheel nuts of a bicycle. The invention allows bicyclists to carry a wheel nut wrench without adding any extra weight to the bicycle, since a U-lock is normally carried anyway. Having a wheel wrench facilitates emergency repairs such as changing tires.

### CROSS-REFERENCE TO RELATED APPLICATIONS

This application claims priority to provisional application No. 61/132,966, filed Jun. 23, 2008, which is hereby incorporated by reference.

Inventors: Lee Weinstein, Bill Sebell

### FIELD OF THE INVENTION

The field of the invention relates to U-locks, bicycle tools, and more specifically to a bicycle U-locks.

### BACKGROUND OF THE INVENTION

As bicycles have become more sophisticated and expensive, the need for good systems to secure bicycles against theft has increased. Within the past 20 years, hardened steel U-locks have become by far the most popular type of bicycle lock due to their sturdy construction, simplicity, and reliability.

One of the most common occasional problems that a cyclist may be faced with is a flat tire. It is not uncommon for cyclists to carry a spare inner tube to repair a flat tire. Although quick-release hubs exist on many bicycles, allowing wheel removal without tools, many bicycles do not have quick-release hubs, and removal of the nuts which attach the wheel axels to the front and rear forks of a bicycle require significant torque to loosen or properly tighten. Carrying tools on a bicycle for such purpose brings extra weight, and the potential for tool loss by theft, should tools be left attached to an unattended bicycle.

### SUMMARY OF THE INVENTION

It is an object of the present invention to provide a bicycle tool suitable for supplying high torque to nuts such as wheel attachment nuts, without significantly increasing the weight of the bicycle-related equipment typically carried by a rider. It is a further object of the present invention to provide a bicycle wrench which can be locked to a bicycle without any added effort beyond the normal effort taken to lock up a bicycle, and without anything extra needing to be remembered when locking up the bicycle.

The present invention provides a method of using part of a bicycle U-lock as the lever arm of a wrench. Because the U-lock is inherently secured when a rider locks up his or her bicycle, no extra effort is needed to secure the wrench. The dimensions of a standard U-lock inherently provide a great enough lever arm to apply the torque needed to attach or remove the most tightly torques fittings on a typical bicycle.

### BRIEF DESCRIPTION OF THE DRAWINGS

FIG. 1 depicts multiple embodiments of a U-lock/wrench according to the present invention.

### DETAILED DESCRIPTIONS OF SOME PREFERRED EMBODIMENTS

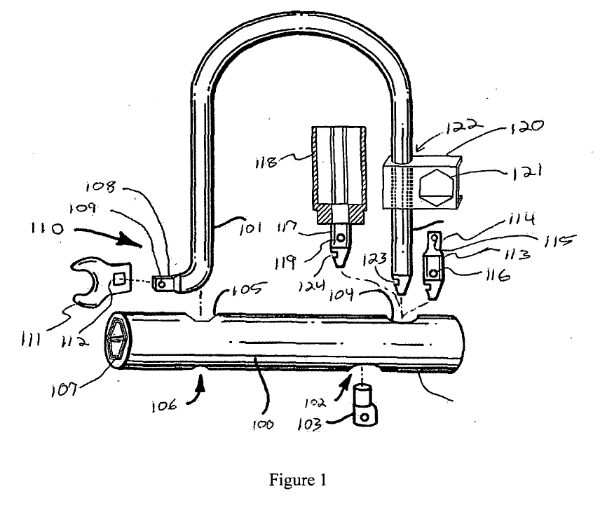

FIG. 1 depicts multiple embodiments of a U-lock/wrench according to the present invention. Tubular bar & lock mechanism 100 and U-bar 101 combine to form a bicycle U-lock. When locked, the lock is assembled such that U-bar 101 passes through clearance hole 105 in at U-bend 110, and the other end of U-bar 101 passes through clearance hole 104 such that the lock mechanism in tubular bar & loch mechanism 100 engages notch 123. Key 103 may be inserted through clearance hole 102 to engage or disengage the lock mechanism from notch 123.

In an embodiment of the present invention where tubular bar 100 acts as a wrench lever arm, socket 118 may be affixed to bar 100 by inserting rod end 117 through clearance hole 104 and engaging notch 124 with the lock mechanism in bar 100 by using key 103. While not in use as a wrench, socket 118 may be worn by a cyclist by passing a cord or chain through hole 119. In this embodiment, the lock mechanism of bar/lock 100 may need to be made stronger than otherwise needed if the lock is required to transmit torque to rod 117 through slot 124. Alternately Rod 117 may be made faceted, and the facets may engage mating facets in clearance hole 104.

In an alternate embodiment utilizing bar 100 as a lever arm, socket adapter 113 may be inserted into hole 104 and locked in place to transmit torque, and a standard socket may be mounted on socket drive 114, which may be equipped with sprung ball 114, designed to engage the inner detent of a standard socket. In such an embodiment, socket adapter 113 may be worn on a key ring, chain, or cord while not in use, by passing such key ring, chain, or cord through hole 116.

In an alternate preferred embodiment using bar 100 as a lever arm, clearance hole 105 may be faceted to effectively become a closed-end wrench, and clearance hole 106 may be provided to allow an extended threaded shaft such as that of a wheel axel to pass though, allowing proper alignment of faceted hole 105 with the nut to which torque is to be applied.

In a preferred embodiment using U-bar 101 as a lever arm, end 108 of U-bar 101 is fashioned into a faceted driver such as a standard socket wrench driver including sprung ball 109 which can engage the internal detents of a standard socket or socket wrench attachment such as crows-foot wrench 111 including drive hole 112. In such an embodiment, crows-foot wrench head 111 may be worn on a chain, cord, or key ring while not in use.

In an alternate preferred embodiment utilizing U-bar 101 as a lever arm, end 107 of tubular bar 100 is formed as the socket of a socket wrench. In such an embodiment, socket end 107 may be formed as multiple concentric slidably coupled sockets, so that different sizes of nuts may be driven.

In an alternate preferred embodiment utilizing U-bar 101 as a lever arm, U-bar 101 slides through holes 122 in box-end-wrench attachment 120, and faceted hole 121 acts to transmits torque to the nut to be tightened or loosened. When not in use as a wrench, box-end-wrench attachment 120 may be left on U-bar 101, or worn on a cord or chain or the like.

In an alternate preferred embodiment, faceted drive surfaces 104 or 108 may be fashioned to directly drive a bolt with a convex drive surface. For instance, surface 108 or 104 could be fashioned as a six-sided allen wrench, spline drive, star-shaped drive, etc.

Within this document, the term “lock bar” shall refer to the portion of a U-lock that engages the U-bar of the U-lock at two areas along the U-bar, allowing the U-bar and lock bar together to form the closed circumference of the U-lock. Within this document, the term “bolt” shall be deemed to refer to any fastener with a threaded shapt, which is tightened by twisting (applying torque). For example, a bolt might include a threaded shaft with concave or convex hexagonal drive surface, such as a standard hex-head bolt, or alien head bolt.

What is claimed is:

1. A method of changing the tightness of a nut or bolt, comprising applying torque to said nut or bolt by using a portion of a U-lock as a lever arm.

2. Means for tightening or loosening a nut or bolt, comprising:
a U-bar, functioning in one aspect as a portion of a U-lock;
a lock bar comprising a lock mechanism, and adapted to engage said U-bar at two places along said U-bar, functioning in one aspect cooperatively with said U-bar to form a U-lock;
a wrench head, such wrench head cooperating with said U-bar or said lock bar in such a way that said U-bar acts as a lever arm to apply torque to said wrench head.

3. Means for tightening or loosening a nut or bolt, comprising:
a U-bar, functioning in one aspect as a portion of a U-lock;
a lock bar comprising a lock mechanism, and adapted to engage said U-bar at two places along said U-bar, functioning in one aspect cooperatively with said U-bar to form a U-lock;
a wrench head, such wrench head cooperating with said U-bar or said lock bar in such a way that said lock bar acts as a lever arm to apply torque to said wrench head.
